(19) United States
(12) Patent Application Publication
(10) Pub. No.: US 2022/0341836 A1
(43) Pub. Date: Oct. 27, 2022

(54) MICROFLUIDIC DEVICE FOR SINGLE CELL PROCESSING AND METHOD AND SYSTEM FOR SINGLE CELL PROCESSING USING THE MICROFLUIDIC DEVICE

(71) Applicant: Singapore University of Technology and Design, Singapore (SG)

(72) Inventors: Ye AI, Singapore (SG); Dahou YANG, Singapore (SG)

(21) Appl. No.: 17/639,355

(22) PCT Filed: Sep. 3, 2020
(86) PCT No.: PCT/SG2020/050513

§ 371 Date: Mar. 1, 2022

(30) Foreign Application Priority Data
Sep. 3, 2019 (SG) 10201908123Q

(51) Int. Cl. G01N 15/10

(52) U.S. Cl. CPC G01N 15/1056; G01N 15/1031

(57) ABSTRACT

There is provided a microfluidic device for single cell processing including: a substrate; a fluidic channel provided in the substrate; and a plurality of electrodes arranged adjacent to the fluidic channel for determining a position of a cell in the fluidic channel, the plurality of electrodes comprising a pair of sensing electrodes comprising a first sensing electrode and a second sensing electrode, wherein at least the first sensing electrode of the pair of sensing electrodes extends in a first direction, the pair of sensing electrodes is configured to measure a differential electrical signal across a sensing region as the cell flows through the sensor portion of the fluidic channel; and a biasing electrode arranged between the first sensing electrode and the second sensing electrode, the biasing electrode being configured to receive a biasing voltage. One of the second sensing electrode and the biasing electrode extends in a direction at least substantially parallel to the first sensing electrode and the other one of the second sensing electrode and the biasing electrode is arranged to have a slanted orientation with respect to the first sensing electrode. There is also provided a method of forming the microfluidic device, and a method and a system for single cell processing using the microfluidic device.

### CROSS-REFERENCE TO RELATED APPLICATION

This application claims the benefit of priority of Singapore Patent Application No. 10201908123Q, filed 3 Sep. 2019, the content of which being hereby incorporated by reference in its entirety for all purposes.

### TECHNICAL FIELD

The present invention generally relates to a microfluidic device for single cell processing, a method of forming the microfluidic device, a method and a system for single cell processing using the microfluidic device.

### BACKGROUND

Cell separation is an essential step in a variety of biomedical applications due to the inherent heterogeneity of biological samples. There are various microfluidic techniques developed for cell separation and sorting, which may be divided as active methods (e.g., dielectrophoresis, acoustophoresis, magnetophoresis) and passive methods (e.g., inertial focusing, on-chip filtration, and deterministic lateral displacement). For all these cell separation techniques, the performance of the system may be characterized, such as the throughput, purity and recovery rate. Traditionally, the performance of microfluidic cell separation and sorting may be evaluated either by analyzing the collected input and output samples (e.g., via flow cytometry, hemocytometer, imaging-based processing) or by detecting the lateral positions of cells using a high-speed camera with post image analysis as such positions are directly linked to the separation performance. The former method requires extra multiple steps of off-chip analysis or expensive equipment (e.g., flow cytometry), which is not readily accessible and inapplicable for real-time analysis. The latter method requires expensive high-speed imaging setup with intricate image processing algorithms or laborious manual analysis. In addition, a high-speed camera produces massive imaging data for post analysis that require high-end computational power, making this approach difficult to realize a real-time measurement of the lateral position of single cells for instantaneous feedback control.

There is a need to develop a simple approach for the lateral position measurement of the flowing particles (e.g., which may also interchangeably be referred to as cells). In this regard, impedance-based microfluidic devices enable a label-free and high-throughput means for cell counting, sizing and studying the cellular function and phenotype. For example, impedance-based microfluidic devices are capable of characterizing the mechanical properties of individual cells through the transit time required for the cell to pass through a constriction channel. More particularly, the transit time may be extracted from the measured electrical signal instead of using high-speed camera video recording. Impedance-based microfluidic cytometry may be employed to measure the cell position in microfluidic channels, including the lateral position (i.e., along the channel width), cross-sectional position (i.e., along the channel width and height) and longitudinal position (i.e., along the channel length). In H. Wang, N. Sobahi and A. Han, Lab Chip, 2017, 17, 1264-1269, they presented a microfluidic system with non-parallel electrodes to detect the lateral position of single particles, which is indicated by the magnitude and width of the signal peak. In B. Brazey, J. Cottet, A. Bolopion, H. Van Lintel, P. Renaud and M. Gauthier, Lab Chip, 2018, 18, 818-831, they demonstrated a longitudinal sensitive position sensor by using a star-shaped electrode design. In M. Solsona, E. Y. Westerbeek, J. G. Bomer, W. Olthuis and A. van den Berg, Lab Chip, 2019, 19, 1054-1059, they developed a microfluidic system to track the particle lateral position by utilizing the electric field gradient induced by two facing electrodes with increasing electro-deposited area. Using this system, the particle lateral position is indicated by the magnitude of the peak. In R. Reale, A. De Ninno, L. Businaro, P. Bisegna and F. Caselli, Microfluid. Nanofluid, 2018, 22, they demonstrated an electrical measurement of cross-sectional position of single particles with two different sets of electrodes, where the particle lateral position can be determined by five pairs of electrodes and two resulting differential currents.

A need therefore exists to provide a microfluidic device for single cell processing, and method and system for single cell processing using the microfluidic device that seek to overcome one or more of the deficiencies of conventional microfluidic devices and conventional methods and systems for single cell processing, such as but not limited to, improving position measurement of the cell (e.g., lateral position, vertical position) in the fluidic channel with improved resolution, improved flow rate and/or improvement in the smallest measured particle size. It is against this background that the present invention has been developed.

### SUMMARY

According to a first aspect of the present invention, there is provided a microfluidic device for single cell processing, the microfluidic device comprising:
a substrate;
a fluidic channel provided in the substrate, wherein the fluidic channel is configured to form a fluid pathway for allowing a fluid sample comprising a cell to flow along the channel; and
a plurality of electrodes arranged adjacent to the fluidic channel for determining a position of the cell in the fluidic channel, the plurality of electrodes comprising:
   a pair of sensing electrodes comprising a first sensing electrode and a second sensing electrode, the pair of sensing electrodes defining a sensing region overlapping with a sensor portion of the fluidic channel, wherein at least the first sensing electrode of the pair of sensing electrodes extends in a first direction, the pair of sensing electrodes is configured to measure a differential electrical signal across the sensing region as the cell flows through the sensor portion of the fluidic channel; and
   a biasing electrode arranged between the first sensing electrode and the second sensing electrode, the biasing electrode being configured to receive a biasing voltage,
wherein one of the second sensing electrode and the biasing electrode extends in a direction at least substantially parallel to the first sensing electrode and the other one of the second sensing electrode and the biasing electrode is arranged to have a slanted orientation with respect to the first sensing electrode.

According to a second aspect of the present invention, there is provided a method of forming a microfluidic device for single cell processing, the method comprising:
providing a substrate;
providing a fluidic channel in the substrate, wherein the fluidic channel is configured to form a fluid pathway for allowing a fluid sample comprising a cell to flow along the channel; and
forming a plurality of electrodes arranged adjacent to the fluidic channel for determining a position of the cell in the fluidic channel, the plurality of electrodes comprising:
   a pair of sensing electrodes comprising a first sensing electrode and a second sensing electrode, the pair of sensing electrodes defining a sensing region overlapping with a sensor portion of the fluidic channel, wherein at least the first sensing electrode of the pair of sensing electrodes extends in a first direction, the pair of sensing electrodes is configured to measure a differential electrical signal across the sensing region as the cell flows through the sensor portion of the fluidic channel; and
   a biasing electrode arranged between the first sensing electrode and the second sensing electrode, the biasing electrode being configured to receive a biasing voltage,
wherein one of the second sensing electrode and the biasing electrode extends in a direction at least substantially parallel to the first sensing electrode and the other one of the second sensing electrode and the biasing electrode is arranged to have a slanted orientation with respect to the first sensing electrode.

According to a third aspect of the present invention, there is provided a method for single cell processing using the microfluidic device for single cell processing as described according to the above-mentioned first aspect, the method comprising:
applying a biasing voltage to the biasing electrode;
obtaining a differential electrical signal based on the first and second sensing electrodes as the cell flows through the sensor portion of the fluidic channel corresponding to the sensing region; and
determining the position of the cell in the sensor portion of the fluidic channel based on the differential electrical signal.

According to a fourth aspect of the present invention, there is provided a system for single cell processing, the system comprising:
the microfluidic device for single cell processing as described according to the above-mentioned first aspect; and
a computing system comprising:
   a memory; and
   at least one processor communicatively coupled to the memory and the microfluidic device, and configured to:
   apply a biasing voltage to the biasing electrode;
   obtain a differential electrical signal based on the first and second sensing electrodes as the cell flows through the sensor portion of the fluidic channel corresponding to the sensing region; and
   determine the position of the cell in the sensor portion of the fluidic channel based on the differential electrical signal.

### BRIEF DESCRIPTION OF THE DRAWINGS

Embodiments of the present invention will be better understood and readily apparent to one of ordinary skill in the art from the following written description, by way of example only, and in conjunction with the drawings, in which:

FIG. 1A depicts a schematic drawing of a microfluidic device for single cell processing, according to various embodiments of the present invention;

FIG. 1B depicts another schematic drawing of a microfluidic device for single cell processing, according to various embodiments of the present invention;

FIG. 1C depicts another schematic drawing of a microfluidic device for single cell processing, according to various embodiments of the present invention;

FIG. 2 depicts a schematic flow diagram of a method of forming a microfluidic device for single cell processing, according to various embodiments of the present invention;

FIG. 3 depicts a schematic flow diagram of a method for single cell processing using a microfluidic device, according to various embodiments of the present invention;

FIG. 4 depicts a schematic drawing of a system for single cell processing, according to various embodiments of the present invention;

FIG. 5 depicts a schematic block diagram of an exemplary computer system in which the system for single cell processing, according to various embodiments of the present invention may be realized or implemented;

FIG. 6A shows a schematic diagram of an electrical sensing region of the microfluidic device according various example embodiments of the present invention;

FIG. 6B illustrates a microscopic image of the electrical sensing region;

FIG. 6C shows a schematic diagram of the sensing region and illustrates an exemplary electrical signal profile of a measured electrical signal from first and second sensing electrodes according various example embodiments of the present invention;

FIG. 7A illustrates a schematic diagram of another exemplary microfluidic device according various example embodiments of the present invention;

FIG. 7B illustrates a schematic diagram of yet another exemplary microfluidic device according various example embodiments of the present invention;

FIG. 7C illustrates an exemplary schematic of a cross-section of a fluidic channel along the channel length, and exemplary signal profile of three different particles flowing through the sensor portion of the fluidic channel corresponding to the sensing region according various example embodiments of the present invention;

FIG. 7D illustrates an exemplary schematic of signal profile of a measured electrical signal of a particle flowing through the sensor portion of the fluidic channel according various example embodiments of the present invention;

FIG. 8A depicts a graph illustrating the experimental results of the measured electrical position x versus transit time t₁/transit time t₂ of three representative beads flowing through the lower (i), middle (ii) and upper (iii) parts of the microchannel according to various example embodiments;

FIG. 8B shows a graph of the corresponding measured differential electrical signal of FIG. 8A, according various example embodiments of the present invention;

FIG. 8C shows the enlarged views of the representative electrical signals of the three representative beads and their corresponding microscopic optical images (captured at the same time) used for the measurement of optical position x, according various example embodiments of the present invention;

FIG. 9 illustrates quantitative comparisons of the lateral position of 10 μm beads between results of the electrical method according to various example embodiments and those obtained by an optical method;

FIG. 10 illustrates the Bland-Altman analysis comparing the lateral position x obtained by the electrical method according to various example embodiments and those obtained by the optical method;

FIGS. 11A-11B show analysis results of the smallest particle which can be detected by the microfluidic device with good performance according to various example embodiments;

FIGS. 12A-12B show the quantitative comparisons of the lateral position of RBCs between results obtained from the microfluidic device according to various example embodiments and those obtained by the optical method;

FIG. 13A-13D illustrate measurements of lateral position x and electrical diameter of the mixture of 5 and 10 μm beads according to various example embodiments;

FIGS. 14A-14B show results of quantitative analysis of the lateral position of 7 μm beads between results obtained from the microfluidic device according to various example embodiments and those obtained by the optical method;

FIG. 15A shows schematic images for monitoring the sheath flows-induced focusing of 7 μm beads at a flow rate according to various example embodiments;

FIG. 15B illustrates the pixel intensity profiles (grayscale) of the images illustrated in FIG. 15A; and

FIG. 15C shows histograms of the electrical position x of 7 μm beads focused in different regions by the sheath flows.

### DETAILED DESCRIPTION

Embodiments of the present invention provide a microfluidic device for single cell processing, a method of forming the microfluidic device, and a method and a system for single cell processing using the microfluidic device. It will be appreciated by a person skilled in the art that the cell may also interchangeably be referred to as a particle. The microfluidic device may be used for the measurement of the position (e.g., lateral, vertical) and determining the position of single cells/particles in continuous flows in a fluidic channel. The position of the cells may be determined using an analytic expression derived from the measured electrical signal and geometrical relationship among the positions of the flowing cells, electrodes and microchannel. Various embodiments of the present invention may be easily integrated with various upstream applications (e.g., cell sorting, cell focusing) for evaluating the efficiency of cell manipulation in a real-time manner and thus eliminate the use of high-speed camera or multiple steps of off-chip analyses. For example, tracking the position of single cells/particles plays an important role in evaluating the efficiency of microfluidic cell focusing, separation and sorting.

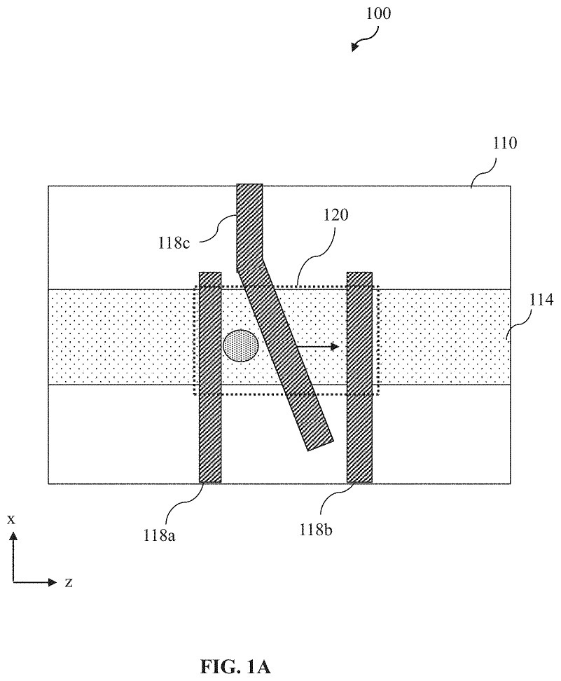

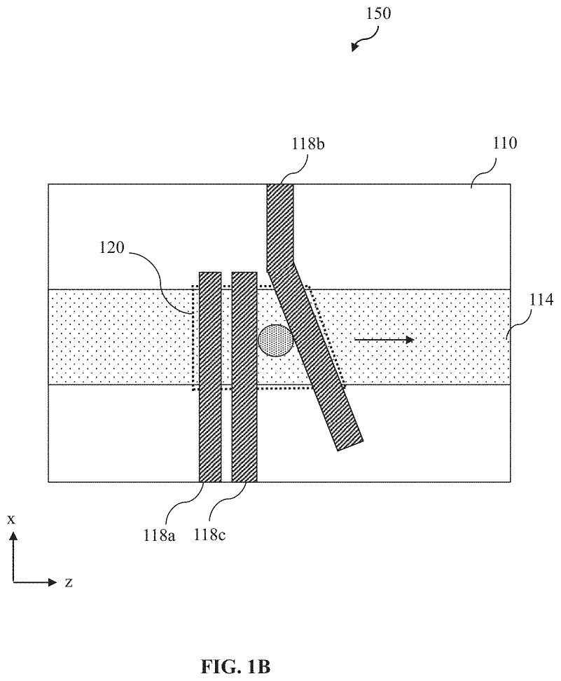

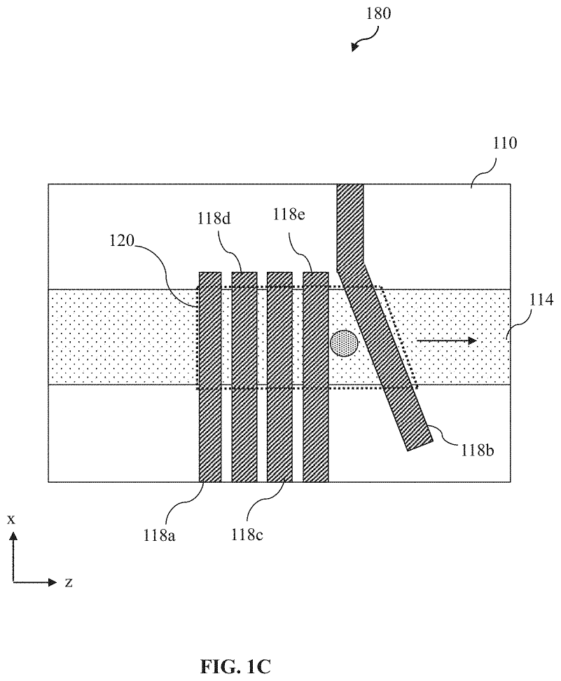

FIG. 1A depicts a schematic drawing illustrating a microfluidic device 100 for single cell processing according to various embodiments of the present invention. The microfluidic device 100 comprises: a substrate 110; a fluidic channel 114 provided in the substrate 110, wherein the fluidic channel is configured to form a fluid pathway for allowing a fluid sample comprising a cell (or a particle) to flow along the channel; and a plurality of electrodes 118 arranged adjacent to the fluidic channel 114 for determining a position of the cell in the fluidic channel. The plurality of electrodes 118 comprises a pair of sensing electrodes comprising a first sensing electrode 118a and a second sensing electrode 118b, the pair of sensing electrodes 118a, 118b defining a sensing region 120 overlapping with a sensor portion of the fluidic channel. At least the first sensing electrode 118a of the pair of sensing electrodes extends in a first direction. The pair of sensing electrodes 118a, 118b is configured to measure a differential electrical signal across the sensing region 120 as the cell flows through the sensor portion of the fluidic channel. The plurality of electrodes 118 further comprises a biasing electrode 118c arranged between the first sensing electrode 118a and the second sensing electrode 118b, the biasing electrode 118c being configured to receive a biasing voltage. One of the second sensing electrode 118b and the biasing electrode 118c extends in a direction at least substantially parallel to the first sensing electrode 118a and the other one of the second sensing electrode 118b and the biasing electrode 118c is arranged to have a slanted orientation with respect to the first sensing electrode 118a.

It can be understood by a person skilled in the art that for illustration purpose only and without limitation, FIG. 1A illustrates an example configuration (e.g., first example configuration) of the microfluidic device 100 where the second sensing electrode 118b extends in a direction at least substantially parallel to the first sensing electrode 118a, and the biasing electrode 118c is arranged to have a slanted orientation with respect to the first sensing electrode 118a and the second sensing electrode 118b (in the sensing region). That is, the second sensing electrode 118b is the above-mentioned one of the second sensing electrode 118b and the biasing electrode 118c extends in a direction at least substantially parallel to the first sensing electrode 118a, and the biasing electrode 118c is the above-mentioned the other one of the second sensing electrode 118b and the biasing electrode 118c is arranged to have a slanted orientation with respect to the first sensing electrode 118a. It will be appreciated by a person skilled in the art that the microfluidic device 100 is not limited to the biasing electrode 118c arranged to have a slanted orientation with respect to the first sensing electrode 118a, and in another example configuration (e.g., second example configuration), the biasing electrode 118c extends in a direction at least substantially parallel to the first sensing electrode 118a, and the second sensing electrode 118b is arranged to have a slanted orientation with respect to the first sensing electrode 118a and the biasing electrode 118c (in the sensing region), such as shown in FIG. 1B.

FIG. 1B depicts a schematic drawing of a microfluidic device 150 for single cell processing according to various embodiments of the present invention, which is similar to the microfluidic device 100, except that the biasing electrode 118c extends in a direction at least substantially parallel to the first sensing electrode 118a, and the second sensing electrode 118b is arranged to have a slanted orientation with respect to the first sensing electrode 118a and the biasing electrode 118c.

In yet another example configuration (e.g., third example configuration), the plurality of electrodes further comprises a pair of floating electrodes (e.g., first floating electrode 1l8d, second floating electrode 118e) extending in the first direction, such as shown in FIG. 1C. FIG. 1C depicts a schematic drawing of a microfluidic device 180 for single cell processing according to various embodiments of the present invention, which is the similar to the microfluidic device 100 and/or 150, except that the plurality of electrodes 118 further comprises a pair of floating electrodes 118d, 118e extending in the first direction. In other words, the pair of floating electrodes 118d, 118e may be arranged in a direction at least substantially parallel to the first sensing electrode 118a.

For the sake of clarity and conciseness, unless stated otherwise, various embodiments of the present invention will be described hereinafter with reference to the microfluidic device 100 having an example configuration as shown in FIG. 1A (i.e., the first example configuration). It will be appreciated by a person skilled in the art that various features and associated advantages described with reference to the first example configuration may similarly, equivalently or correspondingly apply to the second and third example configurations, and thus need not be explicitly stated or repeated for clarity and conciseness.

The above-described configurations of the microfluidic device 100 for single cell processing advantageously provide a number of advantages compared to conventional impedance-based microfluidic devices for measuring the particle position (e.g., lateral position, vertical position) in the fluidic channel, such as but not limited to, an improved resolution, improved flow rate and improvement in the smallest measured particle size (e.g., about 3.6 μm beads). Furthermore, using a mixture of different sized beads (e.g., 5 and 10 μm beads), various embodiments according to the present invention may simultaneously characterize the properties (e.g., size) of single particles/cells in addition to measuring the position (e.g., lateral position, vertical position).

As described, the fluidic channel is configured to form a fluid pathway for allowing a fluid sample comprising a cell to flow along the channel. For example, the fluid sample may be configured to flow in a direction along a length of the channel (i.e., length direction). It will be appreciated by a person skilled in the art that the fluidic channel 114 shown in FIG. 1A (and similarly in FIGS. 1B and 1C) may only illustrate a portion of the fluidic channel of the microfluidic device.

In various embodiments, the fluidic channel may have a width (which may also be interchangeably referred as a channel width) and a height (which may also be interchangeably referred as a channel height).

In various embodiments, the first direction is along a width direction of the fluidic channel. The width direction of the fluidic channel is a direction at least substantially parallel to the channel width. For example, the width direction may be along the x-axis as illustrated in FIGS. 1A-1C. The microfluidic device may further comprise a second direction. In various embodiments, the second direction may be along a height direction of the fluidic channel. The height direction of the fluidic channel is a direction at least substantially parallel to the channel height. For example, the height direction may be along the y-axis in the case the width direction is along the x-axis (y-axis not shown in FIGS. 1A-1C). The x-axis, y-axis and z-axis may be substantially perpendicular to one another.

In various embodiments, the first sensing electrode, the second sensing electrode and the biasing electrode are arranged to form a configuration corresponding to an N-shape. For example, FIG. 1A illustrates the first sensing electrode 118a, the second sensing electrode 118b and the biasing electrode 118c arranged in the sensor region 120 to form a configuration corresponding to an N-shape.

The slanted orientation of the biasing electrode with respect to at least one of the first sensing electrode and the second sensing electrode may be at an angle depending on the dimensions of fluidic channel. In various embodiments, the slanted orientation of the biasing electrode is at an angle ranging from about 10 degrees to about 60 degrees with respect to at least one of the first sensing electrode and the second sensing electrode. In various embodiments, the slanted orientation of the biasing electrode is at an angle of about 22 degrees with respect to at least one of the first sensing electrode and the second sensing electrode.

In various embodiments, the position of the cell comprises a lateral position in the fluidic channel, the lateral position being with respect to a width direction of the fluidic channel and is determined based on a geometrical relationship between the cell and the plurality of electrodes.

In relation to the second example configuration described with respect to FIG. 1B and the third example configuration described with respect to FIG. 1C, in various embodiments, the slanted orientation of the second sensing electrode with respect to the biasing electrode may be at an angle depending on the dimensions of the fluidic channel. In various embodiments, the slanted orientation of the second sensing electrode is at an angle ranging from about 10 degrees to about 60 degrees with respect to the biasing electrode. In various embodiments, the slanted orientation of the second sensing electrode is an angle of about 22 degrees with respect to the biasing electrode.

In various embodiments, the plurality of electrodes further comprises a pair of floating electrodes extending in the first direction. The pair of floating electrodes extends in a direction at least substantially parallel to the first sensing electrode. The pair of floating electrodes are electrodes which are not coupled to any power source.

In various embodiments, the pair of floating electrodes are arranged between the pair of sensing electrodes, and the biasing electrode is arranged between the pair of floating electrodes. As illustrated in FIG. 1C, the pair of floating electrodes 118d, 118e are arranged between the pair of sensing electrodes 118a, 118b and the biasing electrode 118c is arranged between the pair of floating electrodes 118d, 118e.

In various embodiments, the position of the cell comprises a cross-sectional position in the fluidic channel. The cross-sectional position comprises the lateral position in the fluidic channel, the lateral position being with respect to the width direction of the fluidic channel. The cross-sectional position further comprises a vertical position in the fluidic channel, the vertical position being with respect to the height direction of the fluidic channel.

In various embodiments, the biasing voltage comprises an alternating current voltage.

In various embodiments, the differential electrical signal comprises a differential current response across the sensing region.

FIG. 2 depicts a schematic flow diagram of a method 200 of forming a microfluidic device for single cell processing, such as the microfluidic device 100, 150 or 180 as described herein with reference to FIG. 1A, FIG. 1B or FIG. 1C. The method 200 comprises: providing (at 202) a substrate; providing (at 204) a fluidic channel in the substrate, wherein the fluidic channel is configured to form a fluid pathway for allowing a fluid sample comprising a cell to flow along the channel; and forming (at 206) a plurality of electrodes arranged adjacent to the fluidic channel for determining a position of the cell in the fluidic channel, the plurality of electrodes comprising a pair of sensing electrodes comprising a first sensing electrode and a second sensing electrode, the pair of sensing electrodes defining a sensing region overlapping with a sensor portion of the fluidic channel, wherein at least the first sensing electrode of the pair of sensing electrodes extends in a first direction, the pair of sensing electrodes is configured to measure a differential electrical signal across the sensing region as the cell flows through the sensor portion of the fluidic channel; and a biasing electrode arranged between the first sensing electrode and the second sensing electrode, the biasing electrode being configured to receive a biasing voltage, wherein one of the second sensing electrode and the biasing electrode extends in a direction at least substantially parallel to the first sensing electrode and the other one of the second sensing electrode and the biasing electrode is arranged to have a slanted orientation with respect to the first sensing electrode.

In various embodiments, the method 200 is for forming the microfluidic device 100, 150 or 180 as described herein with reference to FIG. 1A, FIG. 1B or FIG. 1C, therefore, the method 200 may further include various steps correspond to providing or forming various configurations and/or components/elements of the microfluidic device 100, 150 or 180 as described herein according to various embodiments, and thus such corresponding steps need not be repeated with respect to the method 200 for clarity and conciseness. In other words, various embodiments described herein in context of the microfluidic device 100, 150 or 180 are analogously or correspondingly valid for the method 200 (e.g., for manufacturing the microfluidic device 100, 150 or 180 having various configurations and/or components/elements as described herein according to various embodiments), and vice versa.

By way of examples only and without limitation, the substrate may be formed of glass (e.g., borosilicate glass), quartz or a polymer wafer. The plurality of electrodes may be formed of suitable electrode materials as are known in the art and thus need not be described herein. By way of an example only and without limitation, the plurality of electrodes may each be formed of electrode materials including a first layer formed of chromium (e.g., having a thickness of about 10 nm) and a second layer formed of gold (e.g., having a thickness of about 100 nm) on the first layer.

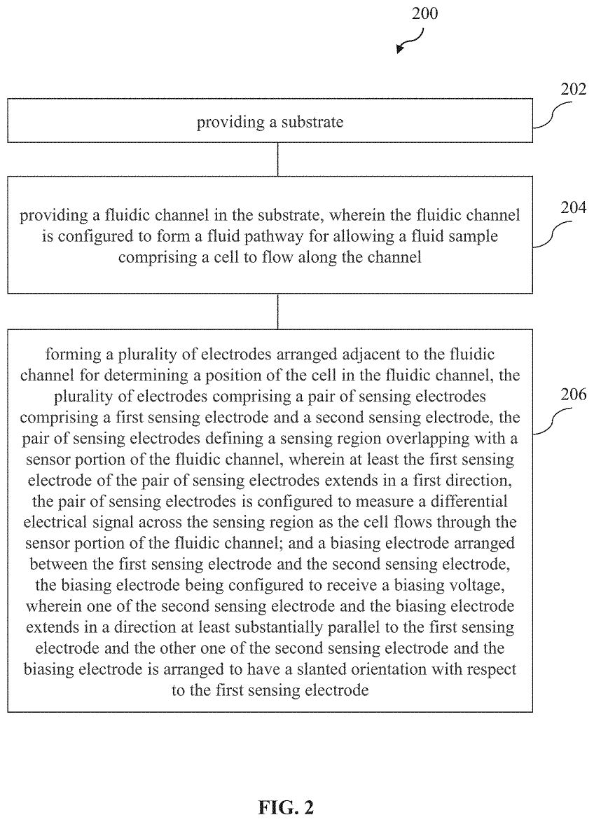

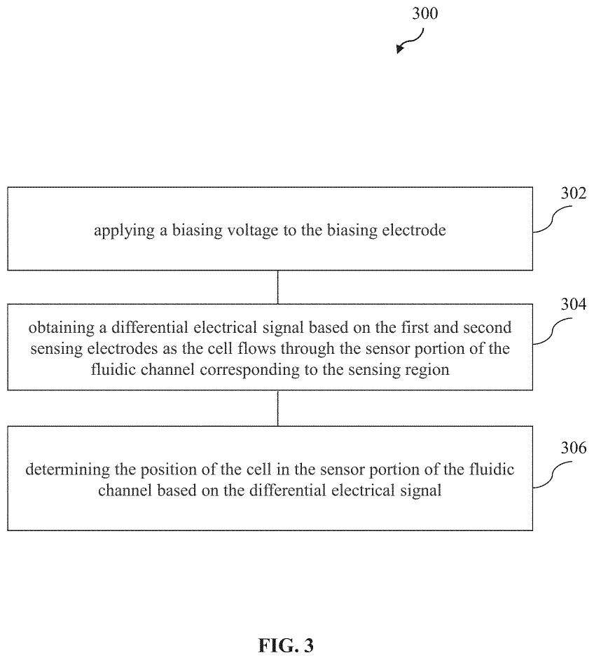

FIG. 3 depicts a schematic flow diagram of a method 300 for single cell processing using the microfluidic device 100, 150 or 180 as described herein with reference to FIG. 1A, FIG. 1B or FIG. 1C according to various embodiments. The method 300 comprises: applying (at 302) a biasing voltage to the biasing electrode; obtaining (at 304) a differential electrical signal based on the first and second sensing electrodes as the cell flows through the sensor portion of the fluidic channel corresponding to the sensing region; and determining (at 306) the position of the cell in the sensor portion of the fluidic channel based on the differential electrical signal.

In various embodiments, the differential electrical signal obtained comprises a plurality of signal peaks corresponding to instances where the cell flowed through the sensor portion of the fluidic channel from the first sensing electrode to the second sensing electrode.

In various embodiments, the plurality of signal peaks comprises a first signal peak corresponding to the cell flowing in the sensor portion of the fluidic channel from the first sensing electrode to the biasing electrode, and a second signal peak corresponding to the cell flowing in the sensor portion of the fluidic channel from the biasing electrode to the second sensing electrode. In various embodiments, the above-mentioned determining the position of the cell in the sensor portion of the fluidic channel comprises determining a lateral position of the cell in the fluidic channel based on a width of the first signal peak and a width of the second signal peak, the lateral position being with respect to a width direction of the fluidic channel. In various embodiments, the width of the first signal peak corresponds to a transit time t₁ of the cell flowing in the sensor portion of the fluidic channel from the first sensing electrode to the biasing electrode, and the width of the second signal peak corresponds to a transit time t₂ of the cell flowing in the sensor portion of the fluidic channel from the biasing electrode to the second sensing electrode.

In various embodiments, the first signal peak and the second signal peak may be of opposite polarity. For example, the first signal peak may be a positive peak, and the second signal peak may be a negative peak. In other embodiments, the first signal peak may be a negative peak, and the second signal peak may be a positive peak.

In various embodiments, the above-mentioned determining a lateral position of the cell in the fluidic channel is further based on a geometrical relationship between the cell and the plurality of electrodes. In other words, the lateral position of the cell in the fluidic channel may be determined based on the differential electrical signal (e.g., the width of the first signal peak corresponding to the transit time t₁, and the width of the second signal peak corresponding to the transit time 12), and geometrical relationship among the positions of the flowing cell, the plurality of electrodes (e.g., first sensing electrode, second sensing electrode, biasing electrode) and the fluidic channel.

In the case where the plurality of electrodes further comprises the pair of floating electrodes, in various embodiments, the first signal peak may comprise first sub-peaks. The first sub-peaks may be twin-peaks. In other words, the first sub-peaks may be symmetrical peaks (e.g., twin-peaks) generated by three parallel electrodes (the first sensing electrode 118a, the first floating electrode 118d and the biasing electrode 118c. In various embodiments, the above-mentioned determining the position of the cell in the sensor portion of the fluidic channel further comprises determining a vertical position of the cell in the fluidic channel based on a ratio of a magnitude of the first sub-peaks to a trough value of the first sub-peaks, the vertical position being with respect to a height direction of the fluidic channel.

In various embodiments, the method 300 may further comprise determining a dimension (e.g., size) of the cell based on a magnitude of the first signal peak and a magnitude of the second signal peak. The dimension of the cell may be a diameter of the cell in a non-limiting example.

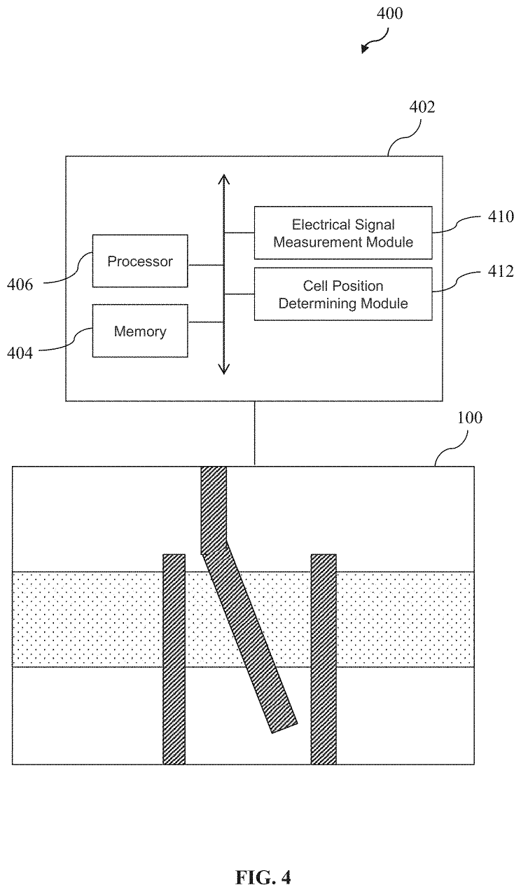

FIG. 4 depicts a schematic drawing of a system 400 for single cell processing according to various embodiments of the present invention, such as corresponding to the method 300 for single cell processing as described hereinbefore with respect to FIG. 3 according to various embodiments. The system 400 comprises the microfluidic device 100, 150 or 180 for single cell processing as described hereinbefore with reference to FIG. 1A, FIG. 1B or FIG. 1C; and a computing system 402 comprising: a memory 404; and at least one processor 406 communicatively coupled to the memory 404 and the microfluidic device 100, and configured to: apply a biasing voltage to the biasing electrode; obtain a differential electrical signal based on the first and second sensing electrodes as the cell flows through the sensor portion of the fluidic channel corresponding to the sensing region; and determine the position of the cell in the sensor portion of the fluidic channel based on the differential electrical signal.

It will be appreciated by a person skilled in the art that the at least one processor 406 may be configured to perform the required functions or operations through set(s) of instructions (e.g., software modules) executable by the at least one processor 406 to perform the required functions or operations. Accordingly, as shown in FIG. 4, the system 400 may comprise an electrical signal measurement module (or circuit) 410 configured to apply a biasing voltage to the biasing electrode; and obtain a differential electrical signal based on the first and second sensing electrodes as the cell flows through the sensor portion of the fluidic channel corresponding to the sensing region; and a cell position determining module (or circuit) 412 configured to determine the position of the cell in the sensor portion of the fluidic channel based on the differential electrical signal.

It will be appreciated by a person skilled in the art that the above-mentioned modules are not necessarily separate modules, and one or more modules may be realized by or implemented as one functional module (e.g., a circuit or a software program) as desired or as appropriate without deviating from the scope of the present invention. For example, the electrical signal measurement module 410 and the cell position determining module 412 may be realized (e.g., compiled together) as one executable software program (e.g., software application or simply referred to as an “app”), which for example may be stored in the memory 404 and executable by the at least one processor 406 to perform the functions/operations as described herein according to various embodiments.

In various embodiments, the computing system 402 corresponds to the method 300 for single cell processing as described hereinbefore with reference to FIG. 3, therefore, various functions or operations configured to be performed by the least one processor 406 may correspond to various steps of the method 300 as described hereinbefore according to various embodiments, and thus need not be repeated with respect to the system 402 for clarity and conciseness. In other words, various embodiments described herein in context of the methods are analogously valid for the respective systems, and vice versa.

For example, in various embodiments, the memory 404 may have stored therein the electrical signal module 410 and the cell position determining module 412, which respectively correspond to various steps of the method 300 as described hereinbefore according to various embodiments, which are executable by the at least one processor 406 to perform the corresponding functions/operations as described herein.

A computing system, a controller, a microcontroller or any other system providing a processing capability may be provided according to various embodiments in the present disclosure. Such a system may be taken to include one or more processors and one or more computer-readable storage mediums. For example, the computing system 402 described hereinbefore may include a processor (or controller) 406 and a computer-readable storage medium (or memory) 404 which are for example used in various processing carried out therein as described herein. A memory or computer-readable storage medium used in various embodiments may be a volatile memory, for example a DRAM (Dynamic Random Access Memory) or a non-volatile memory, for example a PROM (Programmable Read Only Memory), an EPROM (Erasable PROM), EEPROM (Electrically Erasable PROM), or a flash memory, e.g., a floating gate memory, a charge trapping memory, an MRAM (Magnetoresistive Random Access Memory) or a PCRAM (Phase Change Random Access Memory).

In various embodiments, a “circuit” may be understood as any kind of a logic implementing entity, which may be special purpose circuitry or a processor executing software stored in a memory, firmware, or any combination thereof. Thus, in an embodiment, a “circuit” may be a hard-wired logic circuit or a programmable logic circuit such as a programmable processor, e.g., a microprocessor (e.g., a Complex Instruction Set Computer (CISC) processor or a Reduced Instruction Set Computer (RISC) processor). A “circuit” may also be a processor executing software, e.g., any kind of computer program, e.g., a computer program using a virtual machine code, e.g., Java. Any other kind of implementation of the respective functions which will be described in more detail below may also be understood as a “circuit” in accordance with various alternative embodiments. Similarly, a “module” may be a portion of a system according to various embodiments in the present invention and may encompass a “circuit” as above, or may be understood to be any kind of a logic-implementing entity therefrom.

Some portions of the present disclosure are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “applying”, “obtaining”, “determining” or the like, refer to the actions and processes of a computer system, or similar electronic device, that manipulates and transforms data represented as physical quantities within the computer system into other data similarly represented as physical quantities within the computer system or other information storage, transmission or display devices.

The present specification also discloses a computing system (e.g., which may also be embodied as a device or an apparatus), such as the system 402, for performing the operations/functions of the methods described herein. Such a system may be specially constructed for the required purposes, or may comprise a general purpose computer or other device selectively activated or reconfigured by a computer program stored in the computer. The algorithms presented herein are not inherently related to any particular computer or other apparatus. Various general-purpose machines may be used with computer programs in accordance with the teachings herein. Alternatively, the construction of more specialized apparatus to perform the required method steps may be appropriate.

In addition, the present specification also at least implicitly discloses a computer program or software/functional module, in that it would be apparent to the person skilled in the art that the individual steps of the methods described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the invention. It will be appreciated by a person skilled in the art that various modules described herein (e.g., the electrical signal measurement module 410 and/or the cell position determining module 412) may be software module(s) realized by computer program(s) or set(s) of instructions executable by a computer processor to perform the required functions, or may be hardware module(s) being functional hardware unit(s) designed to perform the required functions. It will also be appreciated that a combination of hardware and software modules may be implemented.

Furthermore, various steps of a computer program/module or method described herein may be performed in parallel rather than sequentially. Such a computer program may be stored on any computer readable medium. The computer readable medium may include storage devices such as magnetic or optical disks, memory chips, or other storage devices suitable for interfacing with a general purpose computer. The computer program when loaded and executed on such a general-purpose computer effectively results in an apparatus that implements the steps of the methods described herein.

In various embodiments, there is provided a computer program product, embodied in one or more computer-readable storage mediums (non-transitory computer-readable storage medium), comprising instructions (e.g., the electrical signal measurement module 410 and/or the cell position determining module 412) executable by one or more computer processors to perform a method 300 for single cell processing, as described hereinbefore with reference to FIG. 3. Accordingly, various computer programs or modules described herein may be stored in a computer program product receivable by a system therein, such as the computing system 402 as shown in FIG. 4, for execution by at least one processor 406 of the computing system 402 to perform the required or desired functions.

The software or functional modules described herein may also be implemented as hardware modules. More particularly, in the hardware sense, a module is a functional hardware unit designed for use with other components or modules. For example, a module may be implemented using discrete electronic components, or it can form a portion of an entire electronic circuit such as an Application Specific Integrated Circuit (ASIC). Numerous other possibilities exist. Those skilled in the art will appreciate that the software or functional module(s) described herein can also be implemented as a combination of hardware and software modules.

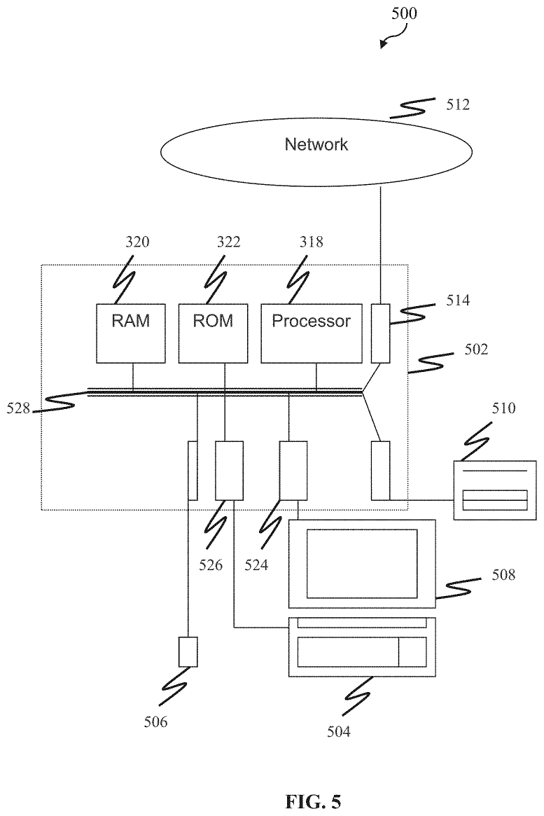

In various embodiments, the computing system 402 may be realized by any computing system (e.g., desktop or portable computing system) including at least one processor and a memory, such as a computing system 500 as schematically shown in FIG. 5 as an example only and without limitation. Various methods/steps or functional modules (e.g., the electrical signal measurement module 410 and/or the cell position determining module 412) may be implemented as software, such as a computer program being executed within the computing system 500, and instructing the computing system 500 (in particular, one or more processors therein) to conduct the methods/functions of various embodiments described herein. The computing system 500 may comprise a computer module 502, input modules, such as a keyboard 504 and a mouse 506, and a plurality of output devices such as a display 508, and a printer 510. The computer module 502 may be connected to a computer network 512 via a suitable transceiver device 514, to enable access to e.g., the Internet or other network systems such as Local Area Network (LAN) or Wide Area Network (WAN). The computer module 502 in the example may include a processor 518 for executing various instructions, a Random Access Memory (RAM) 520 and a Read Only Memory (ROM) 522. The computer module 502 may also include a number of Input/Output (I/O) interfaces, for example I/O interface 524 to the display 508, and I/O interface 526 to the keyboard 504. The components of the computer module 502 typically communicate via an interconnected bus 528 and in a manner known to the person skilled in the relevant art.

It will be appreciated by a person skilled in the art that the terminology used herein is for the purpose of describing various embodiments only and is not intended to be limiting of the present invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

In order that the present invention may be readily understood and put into practical effect, various example embodiments of the present invention will be described hereinafter by way of examples only and not limitations. It will be appreciated by a person skilled in the art that the present invention may, however, be embodied in various different forms or configurations and should not be construed as limited to the example embodiments set forth hereinafter. Rather, these example embodiments are provided so that this disclosure will be thorough and complete, and will fully convey the scope of the present invention to those skilled in the art.

According to various example embodiments of the present invention, there is provided a microfluidic impedance flow cytometry device (which may also interchangeably be referred to as microfluidic device) for single cell processing, such as measuring the position of single cells (e.g., corresponding to the microfluidic device 100, 150 or 180 as described hereinbefore according to various embodiments).

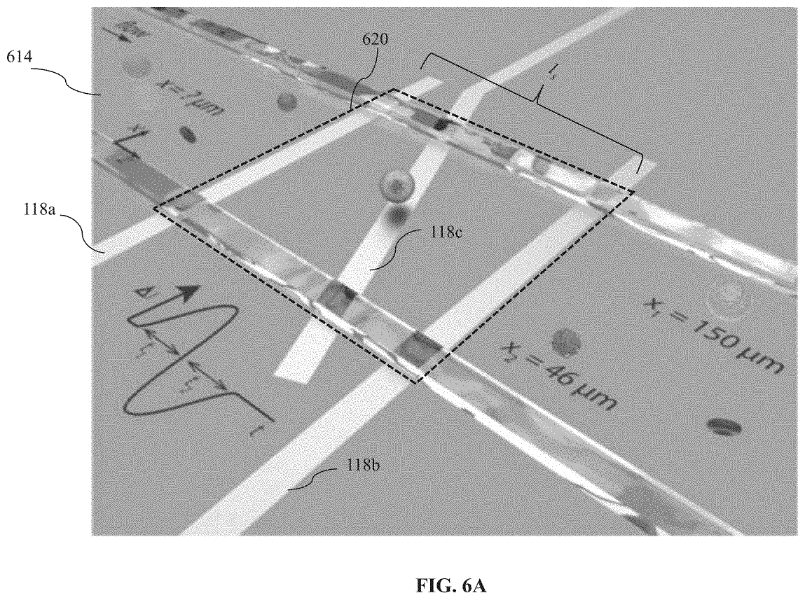

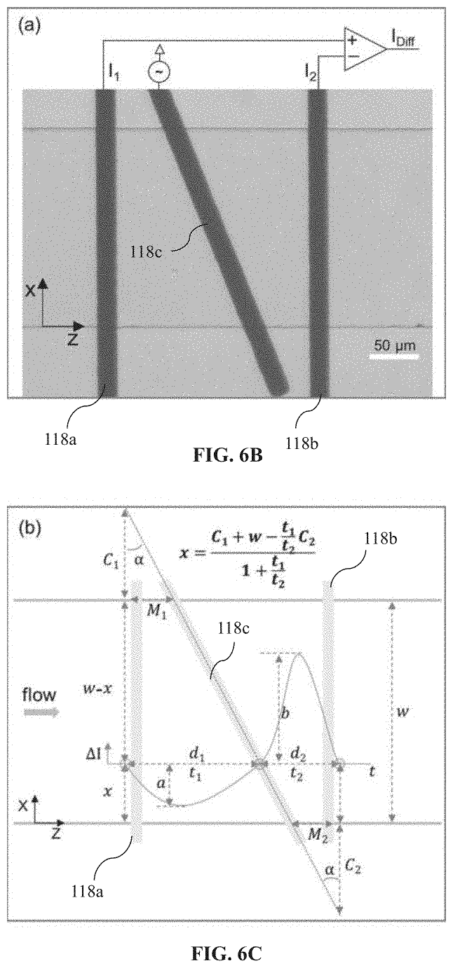

In various example embodiments, the microfluidic impedance flow cytometry device may be used for lateral position measurement of single cells/particles and having an N-shaped electrode design (e.g., corresponding to the plurality of electrodes arranged adjacent to the fluidic channel). A differential current may be collected from the N-shaped electrodes (corresponding to the differential electrical signal measured across the sensing region). The differential current may encode the trajectory of flowing single cells/particles. FIG. 6A shows a schematic diagram of an electrical sensing region of the microfluidic device according various example embodiments of the present invention. In particular, FIG. 6A shows the schematic design of the electrical sensing region 620 in the microfluidic impedance cytometry. The entire fluidic channel (which may also interchangeably be referred to as microchannel) 614 may be visited by cells introduced by a pressure-driven flow. The N-shaped electrodes according to various example embodiments may comprise two outside electrodes (e.g., corresponding to the first and second sensing electrodes 118a, 118b) and one middle slanted electrode (e.g., corresponding to the biasing electrode 118c) which are arranged to detect the passage event of single cells (e.g., detect the passage event of cells individually).

In various example embodiments, the first and second sensing electrodes and biasing electrode may each have a width ranging from about 10 μm to about 40 μm. In various example embodiments, the first and second sensing electrodes and biasing electrode may each have a width of about 20 μm in the case of the microchannel having a width of about 200 μm and a height of about 20 m. The width of the electrodes may depend on the dimensions of the microchannel. The electrical sensing region 620 may have a length 1, (e.g., the space between outside edges of two outside electrodes) of about 240 μm, in various non-limiting examples. In various example embodiments, the biasing electrode 118c may be arranged at a slanted orientation at an angle ranging from about 10 degrees to about 60 degrees with respect to at least one of the first sensing electrode 118a and the second sensing electrode 118c, depending on the dimension of the microchannel. In various example embodiments, the middle electrode may have a slanted angle of about 22 degrees with respect to either of the outside electrodes. The lateral position of single particles/cells flowing through the N-shaped electrodes may be calculated based on the measured electrical signal and the geometry relationship among the positions of the flowing particles, electrodes and microchannel.

FIGS. 6B-6C illustrate the working mechanism of the microfluidic device according various example embodiments of the present invention. FIG. 6B illustrates a microscopic image of the electrical sensing region or area, with notations illustrating the setup of electrical measurement. An alternating current (AC) voltage (e.g., of about 3 V at about 500 kHz) may be applied to the biasing electrode 118c (e.g., middle slanted electrode), in a non-limiting example. A differential current response (Lia) may be measured from the first and second sensing electrodes 118a, 118b (e.g., the other two electrodes).

FIG. 6C shows a schematic diagram of the sensing region or area and illustrates an exemplary electrical signal profile of the measured electrical signal from the first and second sensing electrodes. A geometry relationship among the positions of the flowing cell, the electrodes (e.g., including the first and second sensing electrodes and the biasing electrode) and the fluidic channel is illustrated in FIG. 6C. A pair of opposite signal peaks of the measured electrical signal may be generated due to the passage of a single flowing cell through the sensor portion of the fluidic channel corresponding the sensing region.

According to various example embodiments of the present invention, a simple analytic expression may be derived for the measurement of particle lateral position based on the relationship between the generated electrical current and the positions of the flowing particles, electrodes and microchannel. FIG. 6C also illustrates the analytic expression for the lateral position measurement of the flowing particles, which is derived from the measured electrical signal and geometry relationship among the positions of the flowing particles, electrodes and microchannel, according to various example embodiments.

The analytic expression for the lateral position measurement of the flowing particles may be derived as follows.

Equation (1) describes the relationship between the transit distance d₁, d₂ and transit time t₁, t₂ as follows:

$$\frac{{d}_{1}}{{d}_{2}} = \frac{{t}_{1} * {v}_{1}}{{t}_{2} * {v}_{2}} \qquad Equation ( 1 )$$

where d₁ and d₂ are the transit distance of the flowing cell corresponding to the transit time of t₁ and t₂, respectively. For example, the transit time t₁ refers to the time taken for the cell to travel in the sensor portion of the fluidic channel from the first sensing electrode 118a to the biasing electrode 118c, the transit time t₂ refers to the time taken for the cell to travel in the sensor portion of the fluidic channel from the biasing electrode 118c to the second sensing electrode 118b, the transit distance d₁ refers to the distance for the cell to travel in the sensor portion of the fluidic channel from the first sensing electrode 118a to the biasing electrode 118c during the transit time t₁, the transit distance d₂ refers to the distance for the cell to travel in the sensor portion of the fluidic channel from the biasing electrode 118c to the second sensing electrode 118b during the transit time t₂.

The flow velocity of the cell within the channel in the sensing region may be assumed to be constant (e.g., v₁ is assumed to be equal to v₂ along the electrical sensing region), resulting in Equation (2) as follows:

$$\frac{{d}_{1}}{{d}_{2}} = \frac{{t}_{1}}{{t}_{2}} \qquad Equation ( 2 )$$

For example, as the electrical sensing region has a length lₛ of about 240 μm according to various example embodiments, the flow velocity of the cell within the fluidic channel in the sensing region may be assumed as constant. For example, the flow velocity of the cell within the fluidic channel in the sensing region may be assumed as constant in cases of the sensing region having a small length.

The geometry relationship among the positions of the flowing cell, electrodes and channel may be given by Equation (3) as follows:

$$\frac{{d}_{1}}{{d}_{2}} = \frac{( w - x + {C}_{1} ) * tan ( α )}{( x + {C}_{2} ) * tan ( α )} \qquad Equation ( 3 )$$

where x is the cell lateral position and defined as the distance from the lower channel wall to the center of the cell, and w is the channel width (e.g., 200 μm).

Equation (4) as follows may be derived by combining equations (2) and (3),

$$x = \frac{( w + {C}_{1} - \frac{{t}_{1}}{{t}_{2}} * {C}_{2} )}{1 + \frac{{t}_{1}}{{t}_{2}}} \qquad Equation ( 4 )$$

with

$${C}_{1} = ( {M}_{1} + \frac{D}{2} ) / tan ( α ) and {C}_{2} = ( {M}_{2} + \frac{D}{2} ) / tan ( α ) .$$

The value of M₁, M₂ and α may be known dimensions of the device, which may be 80.3 μm, 76.2 μm and 22°, respectively, in a non-limiting example. D may be the particle's diameter. In a non-limiting example, M₁ may be a sum of the shortest distance between the first sensing electrode 118a and the biasing electrode 118c across the sensor region length l and 1.5 times of electrode width, and M₂ may be a sum of the shortest distance between the biasing electrode 118c and the second sensing electrode 118b across the sensor region length l and 1.5 times of electrode width.

As the magnitude of the peak is proportional to the particle's (or cell's) volume, Equation (5) as follows may be used to estimate the particle's (or cell's) diameter (D).

$$D = G * {( \frac{a + b}{2} )}^{\frac{1}{3}} \qquad Equation ( 5 )$$

where G is the calibration factor depending on the device geometry and electrical properties (e.g., G may be 1.74

$$μ m μ {A}^{- \frac{1}{3}}$$

when calibrated by 10 μm beads according to various example embodiments), a denotes the magnitude of the first signal peak and b denotes the magnitude of the second signal peak. According to Equation (4), the lateral position x may be easily determined from the parameters extracted from the measured electrical signal and known dimensions of the microfluidic device.

In various example embodiments, the lateral positions of beads and human red blood cells (RBCs) measured by the device according to various example embodiments of the present invention have good correlation and agreement with those obtained by conventional microscopic imaging methods.

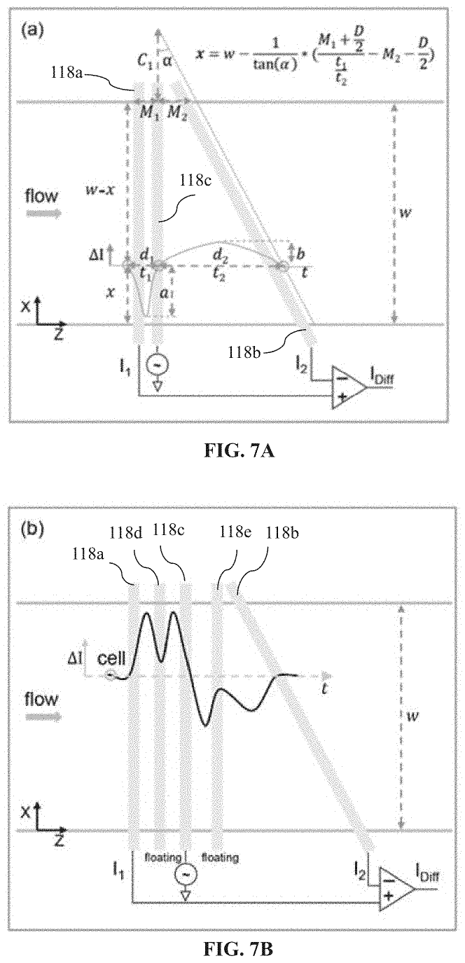

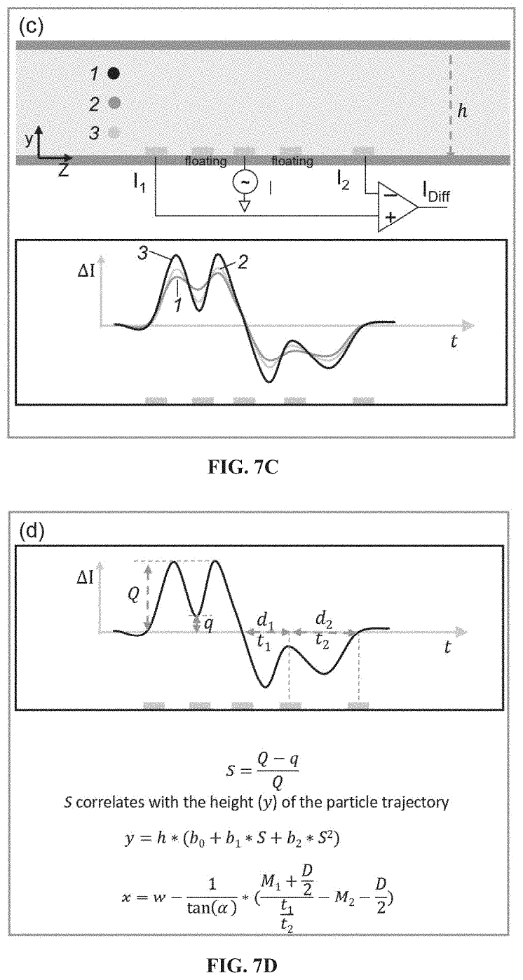

FIGS. 7A-7B illustrate schematic diagrams of another exemplary microfluidic devices according to various example embodiments of the present invention. The microfluidic devices may have different electrode design compared to the microfluidic device described with respect to FIGS. 6A-6C. Referring to FIG. 7A, the biasing electrode 118c extends in a direction at least substantially parallel to the first sensing electrode 118a, and the second sensing electrode 118b is arranged to have a slanted orientation with respect to the first sensing electrode 118a and the biasing electrode 118c. FIG. 7A illustrates the schematic diagram of the sensing area for the lateral position measurement. The lateral position of single particles may be measured by the electrode design with equation (6) as follows, similar to the working principle of the N-shape electrodes of various example embodiments.

$$x = w - \frac{1}{tan ( α )} * ( \frac{{M}_{1} + \frac{D}{2}}{\frac{{t}_{1}}{{t}_{2}}} - {M}_{2} - \frac{D}{2} ) \qquad Equation ( 6 )$$

According to various example embodiments, the electrode design may be integrated with a pair of floating electrodes (e.g., first floating electrode 118d and second floating electrode 118e) extending along the channel width to measure the cross-sectional position of single particles, only requiring one signal output. Accordingly, a cross-sectional position measurement of single cells or particles flowing through a microchannel may be performed with only one electrical signal output. The cross-sectional position may include lateral position and vertical position in the fluidic channel. FIG. 7B illustrates the schematic diagram of the sensing area for the cross-sectional measurement of the flowing particles. By adding two floating electrodes 118d, 118e, the resulting signal profile encodes the height of the particle trajectory (corresponding to vertical position in the fluidic channel).

For example, a first signal peak may be observed as a cell passes from the first sensing electrode 118a to the biasing electrode 118c and a second signal peak may be observed as the cell passes from the biasing electrode 118c to the second sensing electrode 118b. In various example embodiments, the first signal peak may be above the signal baseline (i.e., positive peak) and the second signal peak may be below the signal baseline (i.e., negative peak), as illustrated in FIG. 7B. Alternatively, in other embodiments, the first signal peak may be negative peak and the second signal peak may be a positive peak. As illustrated in FIG. 7B, the first signal peak may comprise first sub-peaks, and the second signal peak may comprise second sub-peaks. The first sub-peaks may be twin-peaks, according to various example embodiments. In other words, the first sub-peaks may be symmetrical peaks (e.g., twin-peaks). The first sub-peaks may be generated by the first three parallel electrodes (the first sensing electrode 118a, the first floating electrode 118d and the biasing electrode 118c).

FIG. 7C illustrates an exemplary schematic of the cross-section fluidic channel along the channel length, and exemplary signal profile of three different particles flowing through the sensor portion of the fluidic channel corresponding to the sensing region. Referring to FIG. 7C, the signal profile changes with the height of the particle trajectory in the fluidic channel.

Referring to FIG. 7D, a relative prominence S correlates with particle vertical position y. The relative prominence S is as follows:

$$S = \frac{Q - q}{Q} \qquad Equation ( 7 )$$

where Q denotes a magnitude of the first sub-peaks (e.g., twin-peaks), and q denotes a trough value between the first sub-peaks.

A quadratic fitting may be used to calculate the vertical position y of the cell as shown in equation (8):

y=h*(b₀+b₁*S+b₂*S²) Equation (8)

where h is the channel height. The parameters bᵢ depend on the experimental setup and may be calculated by the calibration process. Accordingly, the cross-sectional position (i.e., both lateral position x and vertical position y along the cross-sectional plane) of single particles may be measured using only one electrical signal output.

The application of monitoring the focusing of beads is demonstrated according to an example embodiment, showing good agreement with the optical quantification as will be described.

### Experimental Setup and Data Analysis

According to an example experiment conducted, the microfluidic device with N-shaped electrodes may be fabricated. The fluid flow in the microfluidic channel may be controlled using a pressure pump (e.g., Elveflow AF1). In a non-limiting example, the whole microfluidic channel was visited by 3.6, 5, 7, 10 μm beads and human RBCs. Driving pressures of about 300, 500 and 700 mbar were applied to investigate the accuracy of the measurement of particle lateral position at different flow speeds, resulting in the flow rate of about 25.4, 42.4 and 59.3 μl min⁻¹, respectively. Corresponding average flow velocity of the particles is about 0.08, 0.14 and 0.21 m s⁻¹, respectively, which were extracted from a recorded high-speed video. In experiments of monitoring the sheath flows-induced particles focusing, three individual syringe pumps (KD Scientific, Holliston, Mass.) were used to control the fluidic flows. Sample flows (e.g., 7 μm beads) were focused on the bottom (e.g., lower position) (15, 4 and 1 μl min⁻¹), middle (e.g., middle position) (8, 4 and 8 μl min⁻¹) and top (e.g., upper position) (1, 4 and 15 μl min⁻¹) of the fluidic channel (lateral direction x) by sheath flows. Blue food dye was mixed in the sheath flows to show the particle focusing region optically, which was quantified by analyzing the pixel intensity profile of the microscopic image. For example, a software such as ImageJ may be used to analyze grayscale images which carry only the intensity information. The pixel intensity profile is shown after subtracting the baseline.

Electrical current data were recorded by an impedance spectroscope (e.g., HF2IS, Zurich Instruments) and the trajectories of the particles were simultaneously captured by a high-speed camera for comparison. Electrical data were analyzed by a custom-built Matlab program (MATLAB, Mathworks, USA) to provide the lateral position x measured by the electrical method (electrical position x) according to various example embodiments, and the corresponding optical position x was derived from the captured high-speed video using an academically published tracking software (e.g., DMV), which can provide the accurate multiple parameters such as particle lateral position, area and velocity.

Linear regression and Bland-Altman analysis were used to evaluate the correlation and agreement between the electrical and optical method. Root-mean-square deviation (RMSD) of two measures, regularly utilized in model performance studies, was used as a measure of the accuracy of the microfluidic device for the measurement of particle lateral position.

At the low excitation frequencies, the electrical characteristics of a cell is similar to an insulating bead as the cell membrane acting as a capacitance blocks the electrical field lines from penetrating it. As the experiment utilized the AC voltage of low frequency of 500 kHz, measuring the particle lateral position is similar to measuring the cell lateral position. The functionality of the microfluidic impedance cytometry device according to various example embodiments was validated by comparing the electrical position x of flowing 3.6, 5, 7, 10 μm beads and human red blood cells (RBCs) to their optical position x.

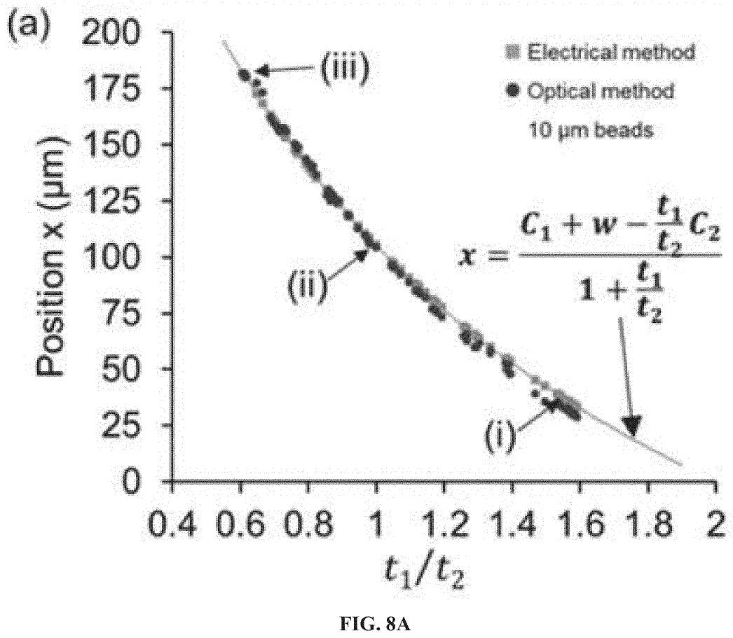

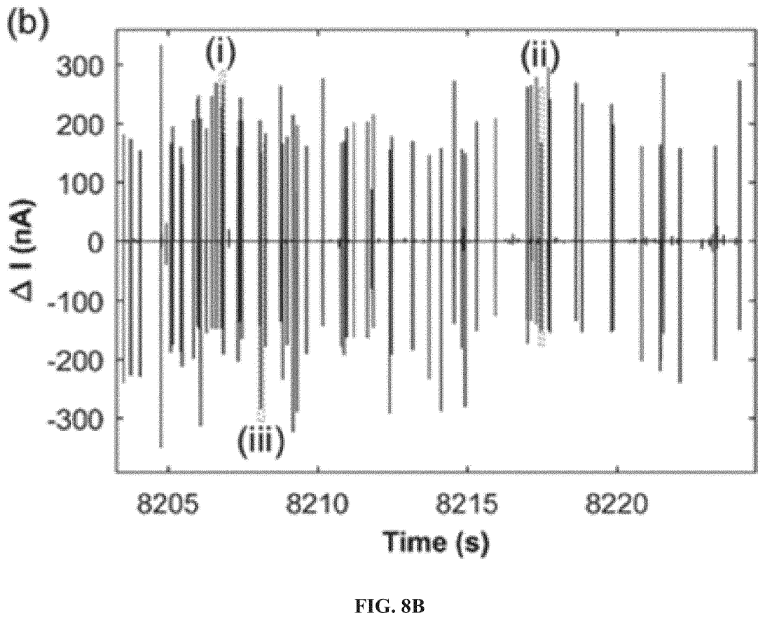

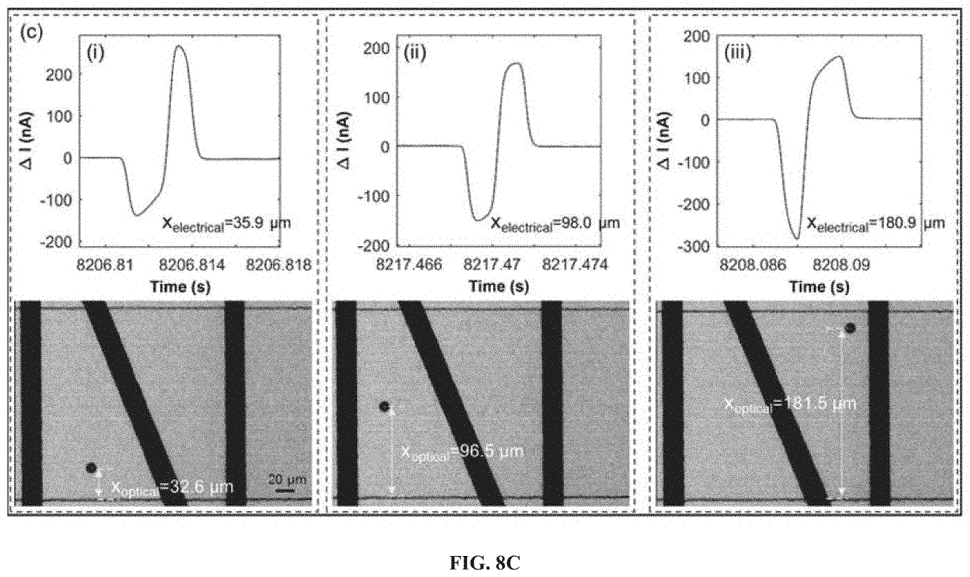

FIG. 8A depicts a graph illustrating the experimental results of the measured electrical position x versus t₁/t₂ of 10 μm beads at the flow rate of 25.4 μl min⁻¹ according to various example embodiments. More particularly, FIG. 8A shows the lateral position of 10 μm beads obtained according to various example embodiments and lateral position obtained from optical method with three representative beads flowing through the lower (i), middle (ii) and upper (iii) part (or position) of the microchannel at the flow rate of 25.4 μl min⁻¹. The position x determined by the optical method versus t₁/t₂ (from the electrical method) is also plotted as a reference. For the comparison of two methods, t₁/t₂ values obtained from the electrical method were used for plotting the corresponding optical lateral position. A graph of the corresponding measured differential electrical signal is illustrated in FIG. 8B.

FIG. 8C shows the enlarged views of the representative electrical signals of three representative beads and their corresponding microscopic optical images (captured at the same time) used for the measurement of optical position x. The position x measured by the electrical method and optical method is in very good agreement, showing comparable results to the optical estimates. For example, for the 10 μm bead (ii) which passes through the relatively middle part or position of the microchannel, the electrical position x of 98.0 μm is comparable to the optical position x of 96.5 μm.

In various example embodiments, because of the unique design of the slanted biasing electrode (e.g., slanted middle electrode) with respect to the first sensing electrode, if the cell passes through the lateral position relatively close to the lower channel wall, the transit time (t₁) of the cell to pass through the first two electrodes (e.g., the first sensing electrode and the biasing electrode) is longer than the transit time (t₂) to pass through the latter two electrodes (e.g., the biasing electrode and the second sensing electrode). This may be due to the distance between the first two electrodes being longer than the latter two electrodes at the lower position of the microchannel. For example, FIG. 8C illustrates a flowing particle (i) where the particle flows relatively close to the lower channel wall. The corresponding current change (a), i.e., magnitude of the first signal peak (e.g., negative peak) is lower than the corresponding current change (b), i.e., magnitude of the second signal peak (e.g., positive peak) from the latter two electrodes because the electrical field of the left side is weaker than the right side. In contrast, if the cell passes through the upper half of the channel as illustrated by the particle (iii), t₁ is shorter than t₂ and the corresponding current change (a), i.e., magnitude of the first signal peak is larger than the corresponding current change (b), magnitude of the second signal peak. In the case of the cell passing through the middle position of the channel as illustrated by the particle (ii), the two peaks are similar indicating that t₁ may be equal to t₂ and the corresponding current change (a), i.e., magnitude of the first signal peak may be equal to the corresponding current change (b), magnitude of the second signal peak.

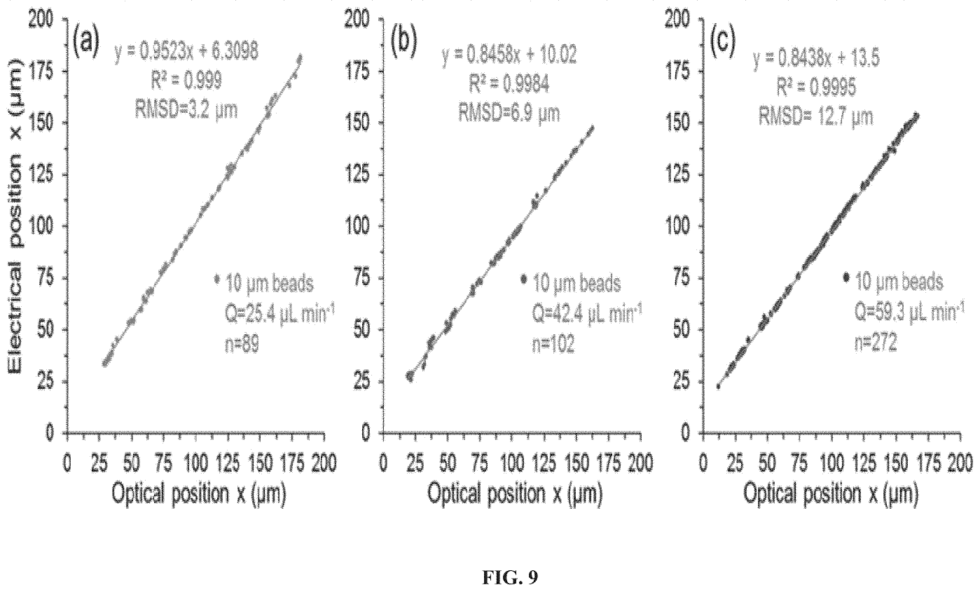

FIG. 9 illustrates quantitative comparisons of the lateral position of 10 μm beads between results of the electrical method according to various example embodiments and those obtained by the optical method. More particularly, FIG. 9 illustrate the electrical position x versus the optical position x of 10 μm beads at the flow rate of (a) 25.4 μl min⁻¹, (b) 42.4 μl min⁻¹ and (c) 59.3 μl min⁻¹. Coefficient of determination R²>0.99 was obtained for the three flow rates, demonstrating a good linear correlation between the electrical method according to various example embodiments and optical method. Root-mean-square deviation (RMSD) was calculated for each flow rate. RMSD of the two measures is 3.2 μm, 6.9 μm and 12.7 μm, corresponding to 1.60%, 3.45% and 6.35% of the channel width, respectively, at the flow rate of 25.4, 42.4 and 59.3 μl min⁻¹, respectively.

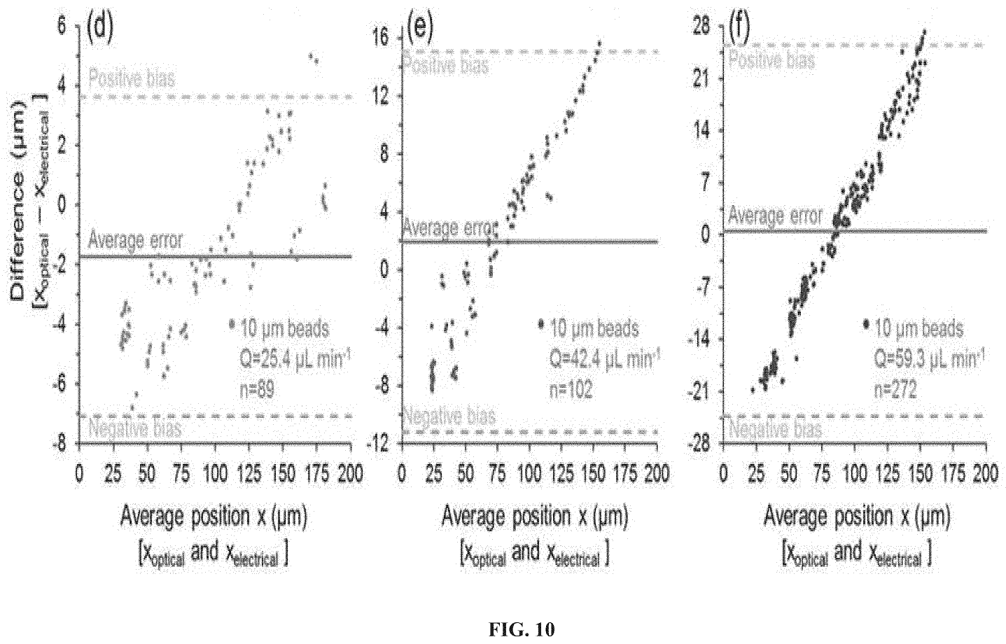

Besides the linear correlation, Bland-Altman analysis was used to study the agreement between the two measures. The Bland-Altman plot is a scatterplot of the difference between two measures against their average. FIG. 10 illustrates the Bland-Altman analysis comparing the lateral position x obtained by the electrical method and optical method at the flow rate of (d) 25.4 μl min⁻¹, (e) 42.4 μl min⁻¹ and (f) 59.3 μl min⁻¹. Most values are well in between the 95% limits of agreement, which are represented as two dotted lines in the figures (i.e., positive bias and negative bias). It can be observed that the electrical position x is higher than the optical position x when the particle passes through the lower half of the channel, resulting in a negative difference. In contrast, there is a positive difference when the particle flows relatively close to the upper channel wall. This is because the electric field strength within left two electrodes is different from the right two electrodes. For the lower half part of N-shaped electrodes, the electric field strength in the left side is weaker than the right side because of the larger gap between left two electrodes compared to the right ones, thereby leading to the electrical signal dropping to the baseline before the particle arrives the central line of the middle electrode. Thus, the value of C₁ used in the equation (4) for the position x calculation is higher than the real one and, on the contrary, C₂ is smaller than the real one, which together result in the higher electrical position x compared to the real position x (i.e., optical position x). Similarly, when the particle flows through the upper part of the N-shaped electrodes, the electric field strength in the left side is stronger than the right side and thus a smaller C₁ and higher C₂ result in the smaller position x from the electrical method.

As shown in FIG. 10, the difference between the two measures is decreasing as the lateral position x gets close to the middle part or position of the channel. This is because the difference of the electric field strength between two pairs of electrodes is decreasing as the position x gets close to the middle part of the N-shaped electrodes (i.e., position x is 100 μm if there is no misalignment between the N-shaped electrodes and the microfluidic channel). It can be found that the RMSD (shown in FIG. 9) and the maximum difference (shown in FIG. 10) increases with the increase in flow rate. This may be due to the difference of electric field strength between two pairs of electrodes increases with the increase in the flow rate. In other words, a higher flow rate will reduce the accuracy of the measurement for the particle lateral position.

Beads with different diameters were used to investigate the minimum particle size that can be measured using the microfluidic device according to various example embodiments. FIGS. 11A-11B show the smallest particle (i.e., 3.6 μm beads) that can be detected by the microfluidic device with good performance. FIG. 11A illustrates a good linear correlation (R²=0.9616) between the electrical method according to various example embodiments and optical method and FIG. 11B shows the Bland-Altman analysis demonstrating the good agreement between the two measures. Root-mean-square deviation (RMSD) of two measures is 11.0 μm (i.e., 5.5% of the channel width) at the flow rate of 25.4 μl min⁻¹.

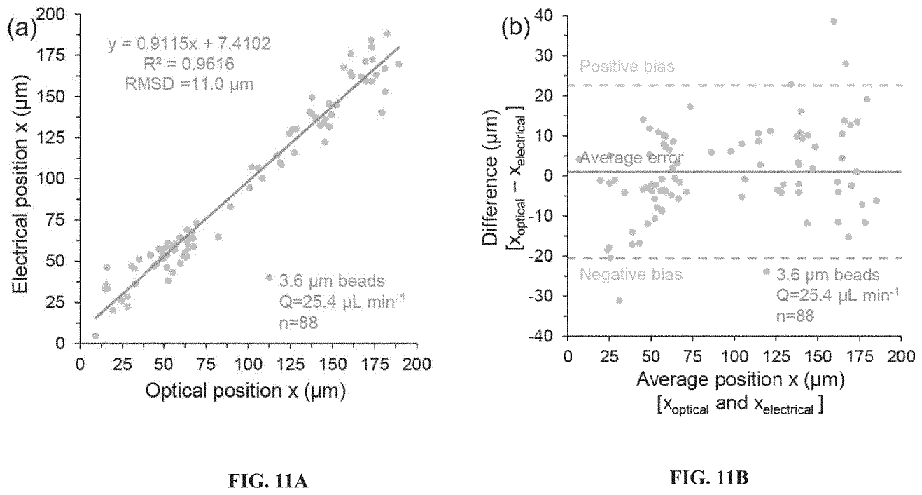

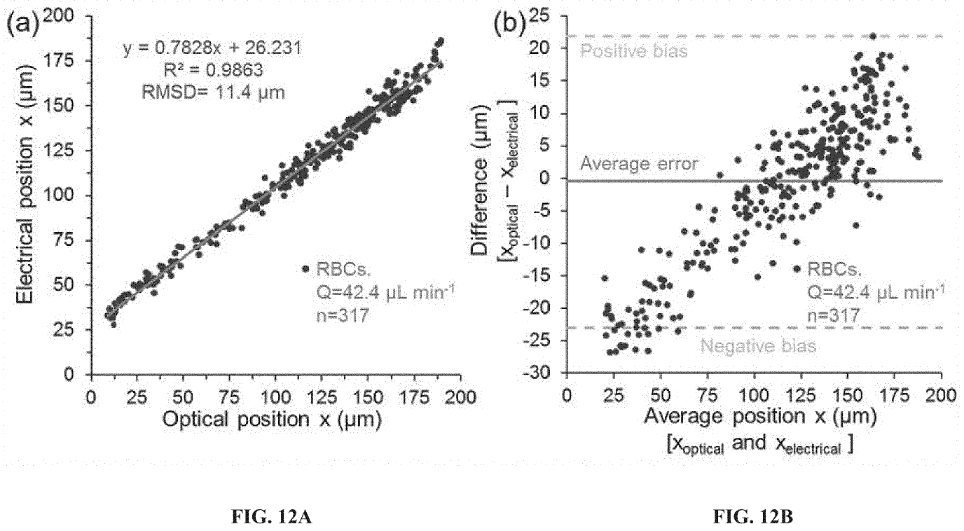

Human red blood cells (RBCs) were used to validate that the microfluidic device according to various example embodiments can be used for the accurate lateral position measurement of single cells. FIGS. 12A-12B show the quantitative comparisons of the lateral position of RBCs between results obtained from the microfluidic device according to various example embodiments and those obtained by the optical method at the flow rate of 42.4 μl min⁻¹. FIG. 12A shows a graph illustrating electrical position x versus optical position x, illustrating a good linear correlation of coefficient of determination (R² of 0.9863) between the two measures and high resolution (RMSD of 11.7 μm, i.e., 5.7% of the channel width). FIG. 12B shows a graph illustrating Bland-Altman analysis comparing the lateral position x obtained by the electrical method and optical method, which shows a good agreement. Most values (94.6%) are well placed between the 95% limits of agreement, which are represented as two dotted lines in FIG. 12B.

### Lateral Position and Size Measurement for the Mixture of 5 and 10 μm Beads

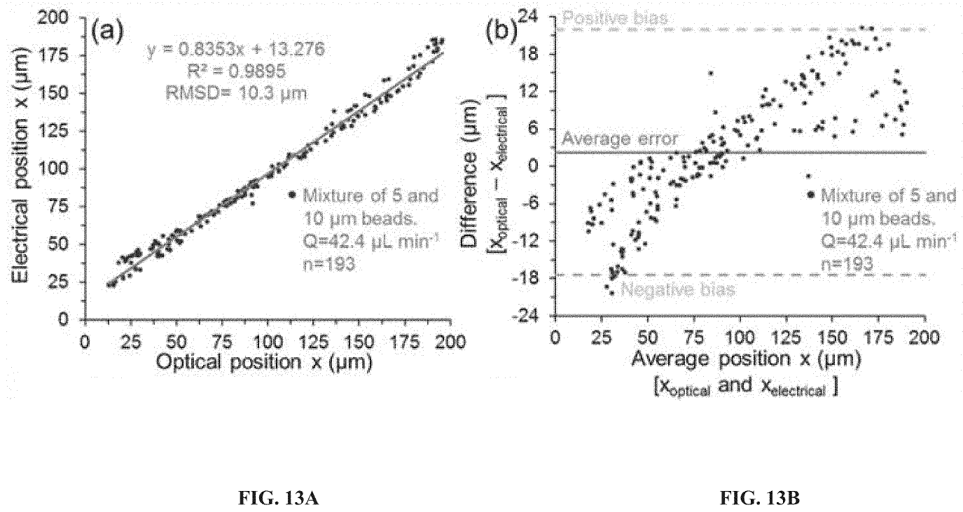

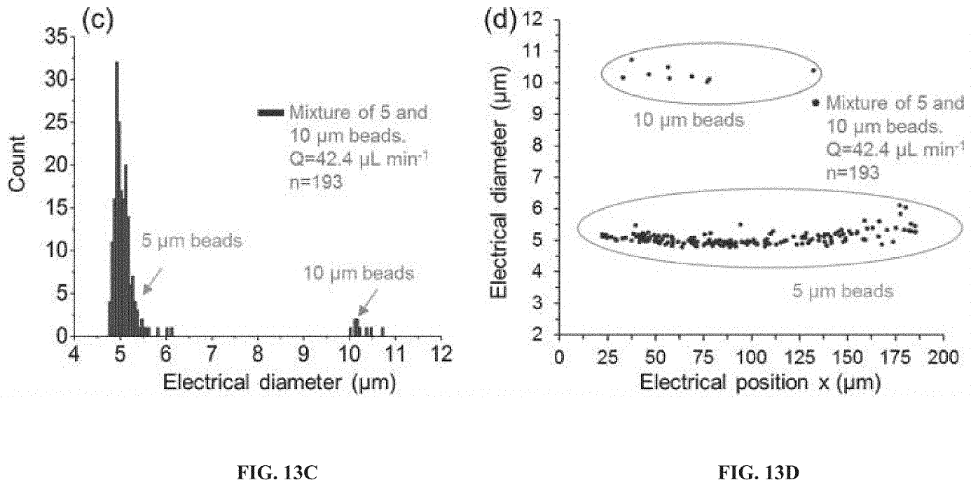

In order to test whether the microfluidic device according to various example embodiments is able to discriminate the cells or particles with different physical properties (e.g., size) flowing through the same position x, the mixture of 5 and 10 μm beads was tested at the flow rate of 42.4 μl min⁻¹. FIG. 13A-13D illustrate measurements of lateral position x and electrical diameter of the mixture of 5 and 10 μm beads at the flow rate of 42.4 μl min⁻¹. FIG. 13A shows the comparison between the electrical position x and optical position x. As shown in FIG. 13A, there is a good linear correlation of coefficient of determination (R²=0.9895) between two measurements, and high resolution (RMSD=10.3 μm, i.e., 5.15% of the channel width).

FIG. 13B shows a graph of the Bland-Altman analysis comparing the lateral position x obtained by the electrical method and optical method. The Bland-Altman analysis demonstrates the good agreement between the two methods. Most values are well in between the 95% limits of agreement, which are represented as two dotted lines. Compared to the results of 10 μm beads at the same flow rate, RMSD increases from 6.9 μm (3.45% of the channel width) to 10.3 μm (5.15% of the channel width) for the mixture where 5 μm beads are the majority. The electrical diameter D is calculated from equation (5) as described above. FIG. 13C shows a histogram of the electrical diameter. As shown in FIG. 13C, two different distributions are clearly observed, corresponding to 5 and 10 μm beads, respectively. FIG. 13D shows a scatter plot of electrical diameter versus electrical position x, demonstrating that the microfluidic device according to various example embodiments does not merely measure the lateral position of the single cells/particles but also may simultaneously characterize their physical properties (e.g., size). As shown in FIG. 13D, two different beads may be clearly distinguished even flowing through the same position x, meaning that the microfluidic device not only can measure the lateral position x of the flowing beads but may also characterize their biophysical properties such as size as demonstrated. This enables evaluation of the efficiency of the cell separation, such as calculating the purity and recovery rate of sorted cells with different size and lateral position.

### Monitoring the Sheath-Flow Induced Particle Focusing

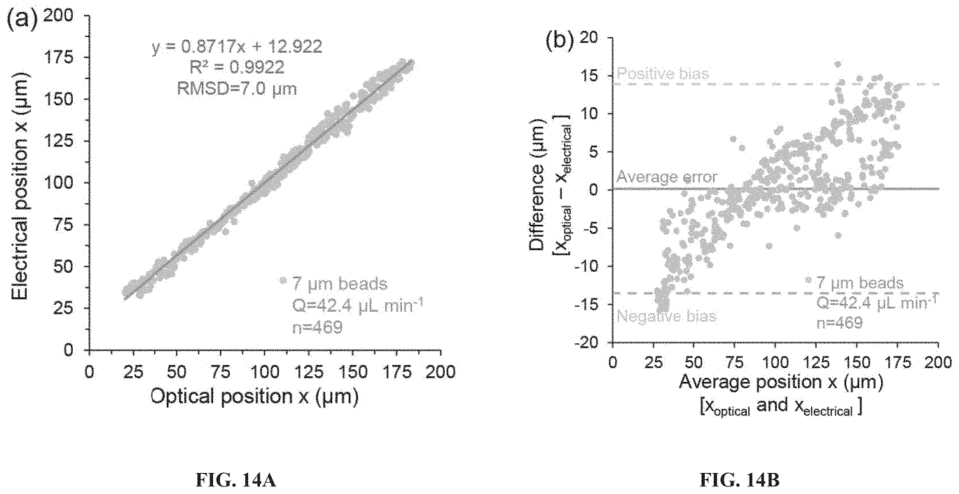

Particle focusing is usually a necessary step prior to detecting, enumerating and sorting particles or cells. The microfluidic impedance cytometry (microfluidic device) according to various example embodiments was applied to monitor the sheath flows-induced particle focusing, where 7 μm beads were suspended in the sample flow. Before the particle focusing experiments, quantitative analysis of the lateral position of 7 μm beads between results obtained from the microfluidic device according to various example embodiments and those obtained by the optical method was performed, as illustrated in FIGS. 14A-14B. A good linear correlation (R²>0.99) and good agreement (Bland-Altman analysis) between the two measures are shown. RMSD is 7.0 μm (i.e., 3.5% of the channel width).

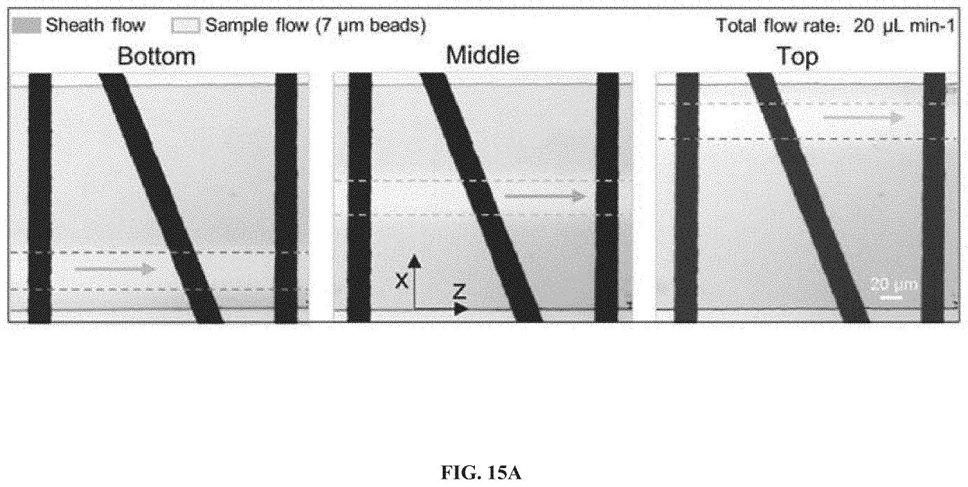

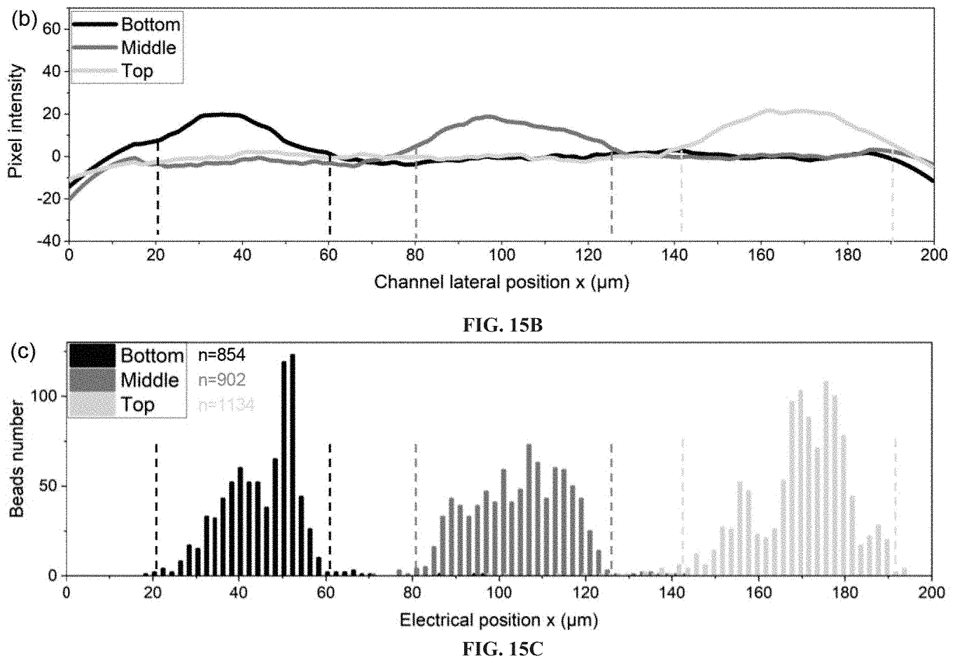

FIG. 15A shows schematic images for monitoring the sheath flows-induced focusing of 7 μm beads at the total flow rate of 20 μl min⁻¹. The images show the boundaries between the sample flow and sheath flows. The images show the sample flow focused in the bottom, middle and top of the channel (lateral direction x) by the sheath flows. FIG. 15B illustrates the pixel intensity profiles (grayscale) of the images illustrated in FIG. 15A, which reflect the particle focusing regions. FIG. 15C shows histograms of the electrical position x of 7 μm beads focused in different regions (in the bottom, middle and top of the channel (lateral direction x)) by the sheath flows. As indicated by the dash lines in FIG. 15B and FIG. 15C, the electrical-based results according to various example embodiments agree well with the optical-based results. For example, for the sample flow focused in the middle of the channel, the focusing region is both around between 80 μm to 125 μm by two methods. These results demonstrate that the microfluidic device according to various example embodiments is capable to accurately determine the lateral position of particles and is a powerful tool for monitoring the particle focusing.

Various example embodiments provide the microfluidic device (e.g., microfluidic impedance cytometry device with N-shaped electrodes) having a more accurate position measurement of single cells/particles at the highest flow rate as compared to conventional impedance-based methods. The position of the cell (e.g., lateral position and/or vertical position) may be directly determined from a simple analytic expression rather than a linear mapping with calibration coefficients in conventional techniques. The functionality of the microfluidic impedance cytometry device according to various example embodiments was validated by comparing the electrical lateral position to the optical lateral position of beads and RBCs. There are good correlation and agreement between the two methods for all cases. A higher resolution of the lateral position measurement may be achieved as compared to conventional impedance-based methods. Experimental results of the mixture demonstrated that the microfluidic device according to various example embodiments not only can measure the position of single cells or particles in the fluidic channel but also can simultaneously study or provide information in relation to their physical properties such as size. Experiments of sheath flows-induced particle focusing demonstrated that the microfluidic device according to various example embodiments is a powerful tool for monitoring and evaluating the particles or cells focusing. The microfluidic device according to various example embodiments thus provides great potential for a real-time characterization of the cell sorting and separation performance.

With the advantages of rapid and accurate processing of electrical signal and high throughput of the impedance flow cytometry, various example embodiments as described may be easily integrated with other microfluidic platforms, for example, as a downstream approach for the real-time measurement of the position (e.g., lateral position, vertical position) and physical properties of single cells and particles.

While embodiments of the invention have been particularly shown and described with reference to specific embodiments, it should be understood by those skilled in the art that various changes in form and detail may be made therein without departing from the scope of the invention as defined by the appended claims. The scope of the invention is thus indicated by the appended claims and all changes which come within the meaning and range of equivalency of the claims are therefore intended to be embraced.

1. A microfluidic device for single cell processing, comprising:
a substrate;
a fluidic channel provided in the substrate, wherein the fluidic channel is configured to form a fluid pathway for allowing a fluid sample comprising a cell to flow along the channel; and
a plurality of electrodes arranged adjacent to the fluidic channel for determining a position of the cell in the fluidic channel, the plurality of electrodes comprising:
a pair of sensing electrodes comprising a first sensing electrode and a second sensing electrode, the pair of sensing electrodes defining a sensing region overlapping with a sensor portion of the fluidic channel, wherein at least the first sensing electrode of the pair of sensing electrodes extends in a first direction, the pair of sensing electrodes is configured to measure a differential electrical signal across the sensing region as the cell flows through the sensor portion of the fluidic channel; and
a biasing electrode arranged between the first sensing electrode and the second sensing electrode, the biasing electrode being configured to receive a biasing voltage,
wherein one of the second sensing electrode and the biasing electrode extends in a direction at least substantially parallel to the first sensing electrode and the other one of the second sensing electrode and the biasing electrode is arranged to have a slanted orientation with respect to the first sensing electrode.

2. The device of claim 1, wherein the second sensing electrode extends in a direction at least substantially parallel to the first sensing electrode, and the biasing electrode is arranged to have a slanted orientation with respect to the first sensing electrode and the second sensing electrode.

3. The device of claim 2, wherein the first sensing electrode, the second sensing electrode and the biasing electrode are arranged to form a configuration corresponding to an N-shape.

4. The device of claim 2, wherein the slanted orientation of the biasing electrode is at an angle ranging from about 10 degrees to about 60 degrees with respect to at least one of the first sensing electrode and the second sensing electrode.

5. The device of claim 1, wherein the position of the cell comprises a lateral position in the fluidic channel, the lateral position being with respect to a width direction of the fluidic channel and is determined based on a geometrical relationship between the cell and the plurality of electrodes.

6. The device of claim 1, wherein the biasing electrode extends in a direction at least substantially parallel to the first sensing electrode, and the second sensing electrode is arranged to have a slanted orientation with respect to the first sensing electrode and the biasing electrode.

7. The device of claim 6, wherein the slanted orientation of the second sensing electrode is at an angle ranging from about 10 degrees to about 60 degrees with respect to the biasing electrode.

8. The device of claim 6, wherein the plurality of electrodes further comprises a pair of floating electrodes extending in the first direction.

9. The device of claim 8, wherein the pair of floating electrodes are arranged between the pair of sensing electrodes, and the biasing electrode is arranged between the pair of floating electrodes.

10. (canceled)

11. The device of claim 1, wherein the differential electrical signal comprises a differential current response across the sensing region.

12. The device of claim 1, wherein the first direction is along a width direction of the fluidic channel.

13. A method of forming a microfluidic device for single cell processing, the method comprising:
providing a substrate;
providing a fluidic channel in the substrate, wherein the fluidic channel is configured to form a fluid pathway for allowing a fluid sample comprising a cell to flow along the channel;
forming a plurality of electrodes arranged adjacent to the fluidic channel for determining a position of the cell in the fluidic channel, the plurality of electrodes comprising:
a pair of sensing electrodes comprising a first sensing electrode and a second sensing electrode, the pair of sensing electrodes defining a sensing region overlapping with a sensor portion of the fluidic channel, wherein at least the first sensing electrode of the pair of sensing electrodes extends in a first direction, the pair of sensing electrodes is configured to measure a differential electrical signal across the sensing region as the cell flows through the sensor portion of the fluidic channel; and
a biasing electrode arranged between the first sensing electrode and the second sensing electrode, the biasing electrode being configured to receive a biasing voltage,
wherein one of the second sensing electrode and the biasing electrode extends in a direction at least substantially parallel to the first sensing electrode and the other one of the second sensing electrode and the biasing electrode is arranged to have a slanted orientation with respect to the first sensing electrode.

14. The method of claim 13, wherein the second sensing electrode extends in a direction at least substantially parallel to the first sensing electrode, and the biasing electrode is arranged to have a slanted orientation with respect to the first sensing electrode and the second sensing electrode.

15. The method of claim 14, wherein the first sensing electrode, the second sensing electrode and the biasing electrode are arranged to form a configuration corresponding to an N-shape.

16-21. (canceled)

22. A method for single cell processing using the microfluidic device according to claim 1, the method comprising:
applying a biasing voltage to the biasing electrode;
obtaining a differential electrical signal based on the first and second sensing electrodes as the cell flows through the sensor portion of the fluidic channel corresponding to the sensing region; and
determining the position of the cell in the sensor portion of the fluidic channel based on the differential electrical signal.

23. The method of claim 22, wherein the differential electrical signal obtained comprises a plurality of signal peaks corresponding to instances where the cell flowed through the sensing portion of the fluidic channel from the first sensing electrode to the second sensing electrode.

24. The method of claim 22:
wherein the plurality of signal peaks comprises a first signal peak corresponding to the cell flowing in the sensor portion of the fluidic channel from the first sensing electrode to the biasing electrode and a second signal peak corresponding to the cell flowing in the sensor portion of the fluidic channel from the biasing electrode to the second sensing electrode; and
said determining the position of the cell in the sensor portion of the fluidic channel comprises determining a lateral position of the cell in the fluidic channel based on a width of the first signal peak and a width of the second signal peak, the lateral position being with respect to a width direction of the fluidic channel.

25. The method of claim 24, wherein said determining a lateral position of the cell in the fluidic channel is further based on a geometrical relationship between the cell and the plurality of electrodes.

26. The method of claim 24, wherein the first signal peak comprises first sub-peaks, and said determining the position of the cell in the sensor portion of the fluidic channel further comprises determining a vertical position of the cell in the fluidic channel based on a ratio of a magnitude of the first sub-peaks to a trough value of the first sub-peaks, the vertical position being with respect to a height direction of the fluidic channel.

27. The method of claim 24, further comprising determining a dimension of the cell based on a magnitude of the first signal peak and a magnitude of the second signal peak.

28. (canceled)
